(19) United States
(12) Patent Application Publication
(10) Pub. No.: US 2010/0195350 A1
(43) Pub. Date: Aug. 5, 2010

(54) Modular LED light device

(76) Inventors: Richard Schattinger, New York, NY (US); Derek J. Gabriels, Bay Shore, NY (US)

Correspondence Address: WILSON DANIEL SWAYZE, JR., 3804 CLEARWATER CT., PLANO, TX, 75025, US

(21) Appl. No.: 12/699,348

(22) Filed: Feb. 3, 2010

Related U.S. Application Data
(60) Provisional application No. 61/149,479, filed on Feb. 3, 2009.

(51) Int. Cl. F21V 8/00; F21V 21/00

(52) U.S. Cl. 362/612; 362/633

(57) ABSTRACT

A modular lighting device may include A frame housing, a light emitting panel cooperating with the frame housing to emit light, an edge lighting device to be positioned along an edge of the light emitting panel to provide light to the light emitting panel, a film member including indicia to be displayed, and a modular member to cooperate with the frame housing and the film member. The modular member may be detachably connected to the frame housing. The edge lighting device may include an LED, and the edge lighting device may include an array of LEDs. The light emitting panel may include a depression to transmit the emitted light, and the module member may include a fastener to fasten to the frame housing. The fastener may be L-shaped, and the module member may include a top extending portion and a bottom extending portion to cooperate with the top extending portion to form a substantially continuous surface.

### PRIORITY

The present invention claims priority under 35 USC section 119 which is based on a provisional application with a Ser. No. 61/149,479 which was filed on Feb. 3, 2009.

### FIELD OF THE INVENTION

This invention is directed to an edge-lit backlighting device for light emitting diode displays, and, more particularly, to a backlighting device employing at least one light stripe which mounts a plurality of light engines having an array of densely packed, primary color light emitting diodes (“LEDs”).

### BACKGROUND

In recent years, there have been developed light-emitting diodes capable of emitting red, green, and blue colors (hereinafter referred to as “RGB” in some cases) and light-emitting diodes which are formed of light emitting elements in combination with phosphor materials so that they emit various colors, such as a white color, with a high brightness. Since a light-emitting diode (hereinafter referred to as an “LED”) is a solid-state element, it has superior resistance against vibration, a low-power consumption rate, a long operating life, and superior drive properties such as a high-speed drive. Accordingly, the light-emitting diodes have been increasingly used for various applications such as light sources for signal heads and full-color LED displays.

Light-emitting diode devices having various sizes and display effects have been developed and are available in the market. Depending on the complexity of required illumination pattern, most of the light-emitting diode devices include arrays of light-emitting diodes selectively switched on/off to generate such illumination pattern. When a complex illumination pattern is desired, the number of required light-emitting diodes can be significant.

### SUMMARY

A modular lighting device may include A frame housing, a light emitting panel cooperating with the frame housing to emit light, an edge lighting device to be positioned along an edge of the light emitting panel to provide light to the light emitting panel, a film member including indicia to be displayed, and a modular member to cooperate with the frame housing and the film member.

The modular member may be detachably connected to the frame housing.

The edge lighting device may include an LED, and the edge lighting device may include an array of LEDs.

The light emitting panel may include a depression to transmit the emitted light, and the module member may include a fastener to fasten to the frame housing.

The fastener may be L-shaped, and the module member may include a top extending portion and a bottom extending portion to cooperate with the top extending portion to form a substantially continuous surface.

The frame housing may include a slot to cooperate with the fastener and the frame housing may include a central slot to cooperate with the light emitting panel.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates an exploded view of the modular LED light device of the present invention.

FIG. 2 illustrates a perspective view of the modular LED light device of the present invention;

FIG. 3 illustrates a perspective view of the frame housing of the modular LED light device of the present invention;

FIG. 4 illustrates a sectional view of the frame housing;

FIG. 5 illustrates a another sectional view of the frame housing;

FIG. 6 illustrates a front view of the frame housing;

FIG. 7 illustrates a side view of the frame housing;

FIG. 8 illustrates a top view of the frame housing;

FIG. 9 illustrates a front view of another frame housing of the present invention;

FIG. 10 illustrates a bottom view of the frame housing of the present invention;

FIG. 11 illustrates a top view of the frame housing of the present invention;

FIG. 12 illustrates a side view of the frame housing of the present invention;

FIG. 13 illustrates a front view of the film member of the present invention;

FIG. 14 illustrates a bottom view of the film member of the present invention;

FIG. 15 illustrates a first side view of the film member of the present invention;

FIG. 16 illustrates a top view of the film member of the present invention;

FIG. 17 illustrates a side view of the film member of the present invention;

FIG. 18 illustrates a front view of the LED array light device;

FIG. 19 illustrates a perspective view of the LED array light device;

FIG. 20 illustrates a another front view of the LED light array light device;

FIG. 21 illustrates a front view of the modular member;

FIG. 22 illustrates a cross-sectional view of the modular member;

FIG. 23 illustrates a side view of the modular member;

FIG. 24 illustrates a first and second modular member;

FIG. 25 illustrates a sectional view of the first and second modular member;

FIG. 26 illustrates a side view of the light emitting panel.

### DETAILED DESCRIPTION

The present invention includes a modular LED light device which may include a frame housing which may vary in size and shape and cooperates with an interchangeable graphic module which may incorporate an edgelit panel or panels. The frame housing may be mounted as a merchandising wall, a wall mount signage, an end cap, a hanging sign, a window display or a floor stand display. The module member may include an interlock/interchangeable molded graphic module(s) which may hold translucent graphics such as a one large graphic message or multiple messaging possibilities and provides for easy change out of graphic images. They LED array light device may include for lighting shelving, showcases, handing rails or peg hooks.

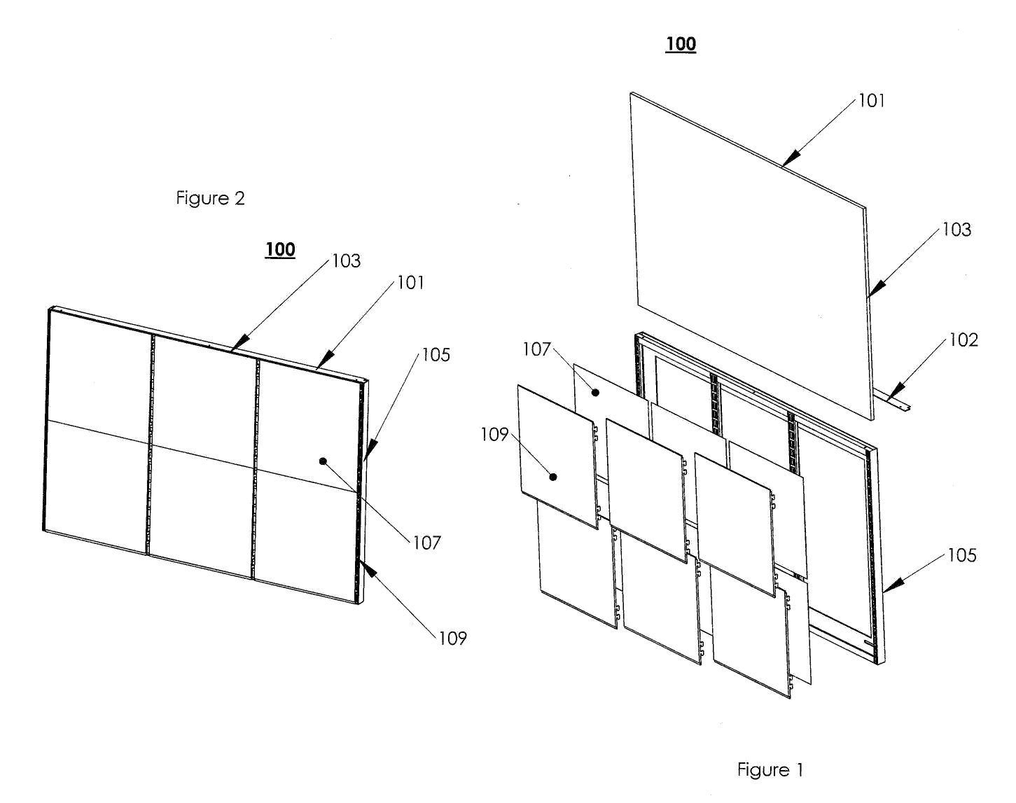

FIG. 1 illustrates an exploded view of the modular LED light device 100 which may include an array of LED light devices 103 and a light emitting panel 101 which may be etched by a laser to allow the LED light device 103 to be placed along at least one edge of the light emitting panel 101. The depressions created by the etching of the laser allow the light from the LED light device 103 to be distributed in a substantially even fashion so that the light emitting panel 101 may emit light substantially uniformly. FIG. 1 additionally illustrates a fastening device 102 such as a strap to secure the LED panel 101 within the housing 105. The light emitting panel 101 may be detachably positioned within a central slot of the frame housing 105. The light emitting panel 101 may be removed and replaced from the frame housing 105.

FIG. 1 additionally illustrates a film member 107 which may be a sheet of film or other material and may include indicia to be displayed, and the film member 107 may allow light from the light emitting panel 101 to pass through the film member 107. The film member 107 may cooperate and be mounted within a module member 109 which may include a frame around the periphery of the module member 109. The module member 109 may overlap or interlock within adjacent module member 109 in order to provide a continuous appearance.

FIG. 2 illustrates a perspective view of the modular LED light device 100 which may include a light emitting panel 101, a LED array light device 103, a frame housing 105, the film member 107 and the module member 109.

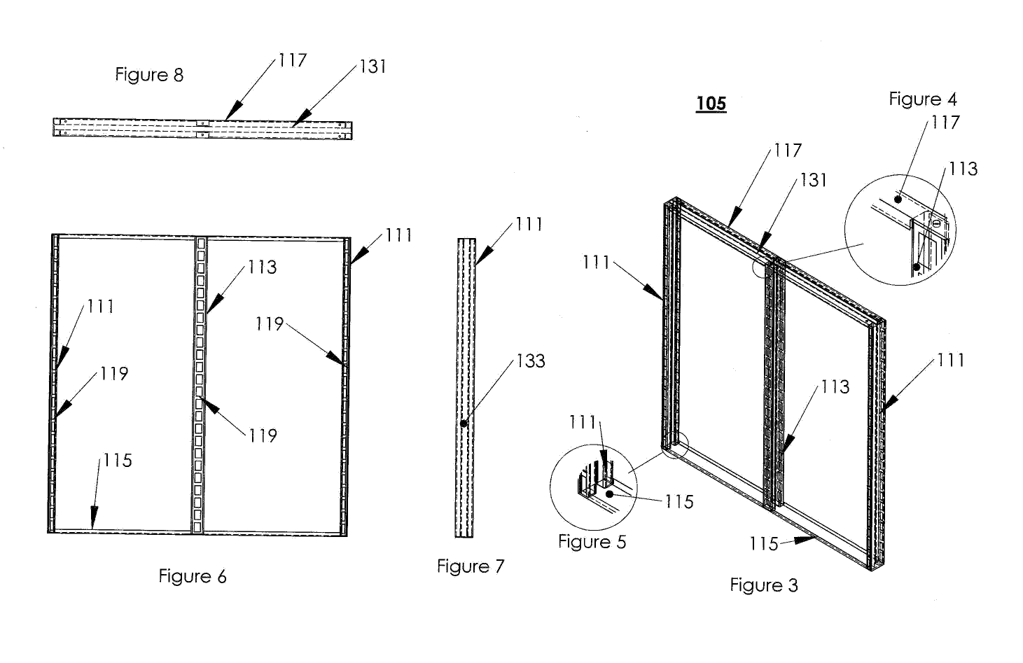

FIG. 3 illustrates a perspective view of the frame housing 105 which may include an outer side frame member 111, an opposing outer side frame member 111 which may be connected to a top frame member 117 and a bottom frame member 115 which may be connected to a center frame member 113. The outer surface of the outer side frame member 111 and the center frame member 113 may include slots 119, and the top frame member 117 may include a center slot 131 to allow the light emitting panel 101 to be removed and replaced within the frame housing 105.

FIG. 4 illustrates a sectional view of the connection between the top frame member 117 and the center frame member 113.

FIG. 5 illustrates a sectional view of the connection between the outer side frame member 111 and the bottom frame member 115.

FIG. 6 illustrates a front view of the frame housing 105 and illustrates the outer side frame member 111, the center frame member 113, the bottom frame member 115 and the top frame member 117. FIG. 6 additionally illustrates the slots 119.

FIG. 7 illustrates a side view of the frame housing 105 and illustrates the outer side frame which may include a center slot 113 which may be formed in the interior surface of the outer side frame 111 in order to guide and retain the light emitting panel 101.

FIG. 8 illustrates a top view of the frame housing 105 and illustrates the top frame member 117 and the center slot 131 in order to guide and retain the light emitting panel 101.

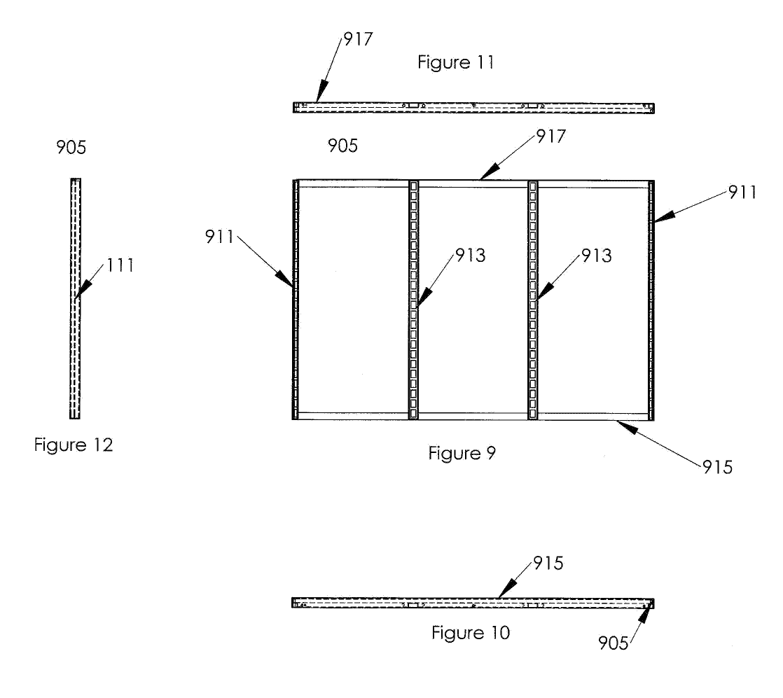

FIG. 9 illustrates another frame housing 905 which may include a pair of outer side frame members 911, a pair of center frame members 913 (or additional center frame members are within the scope of the invention), a bottom frame member 915 and a top frame member 917.

FIG. 10 illustrates a bottom view of the frame housing 905 and illustrates the bottom frame member 915.

FIG. 11 illustrates a top view of the frame housing 905 and illustrates the top frame member 917.

FIG. 12 illustrates a side view of the frame housing 905 and illustrates the outer side frame member 111.

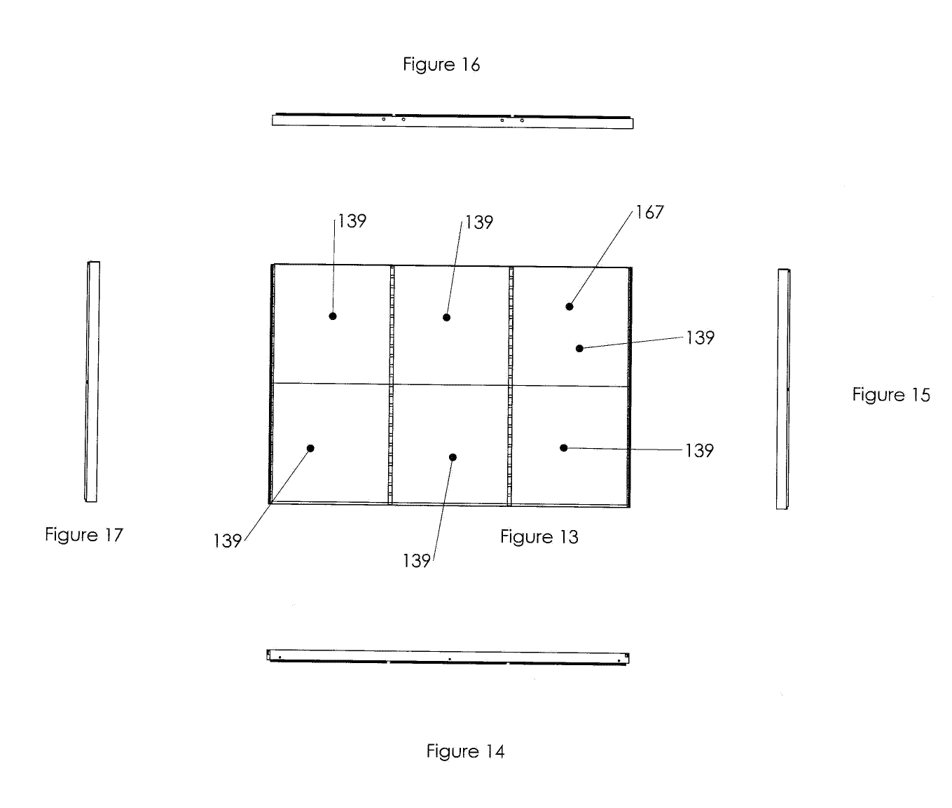

FIG. 13 illustrates a front view of the film member 107 which has been formed into substantially rectangular portions 139 which may be formed from translucent or transparent material and may include indicia. The portion 139 may be any shape and may be formed to be inserted into the modular member 109.

FIG. 14 illustrates the bottom surface of the portion 139, and FIG. 16 illustrates the top surface of the portion 139.

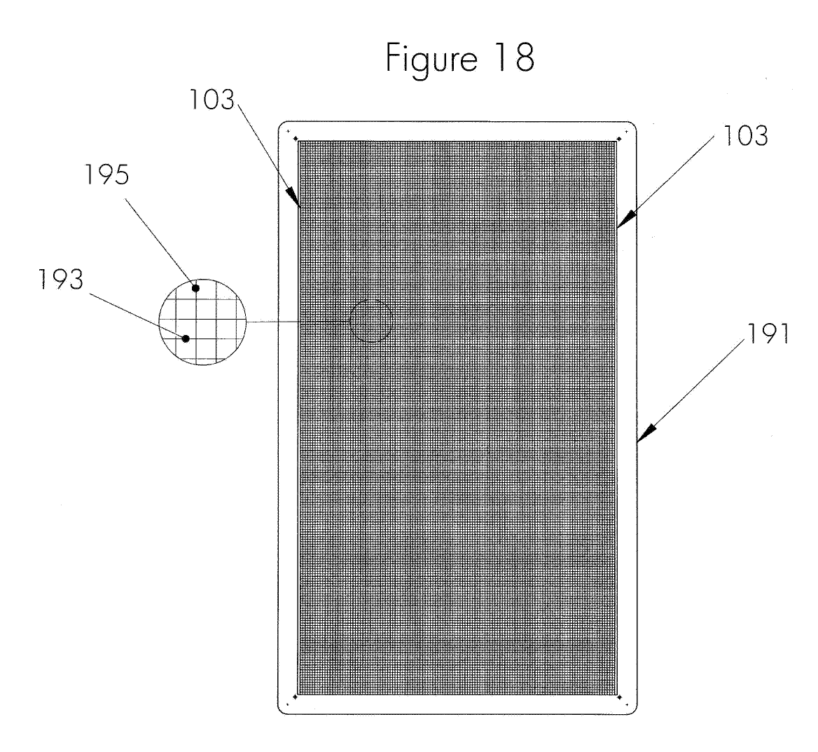

FIGS. 15 and 17 illustrate the side surface of the portion 139.

FIG. 18 illustrates a front view of the light emitting panel 101 which may include a LED array light device 103 which may include LED lights 191 positioned along the periphery of the light emitting panel 101 and may include a second array of LED lights 103 positioned on an opposing periphery of the light emitting panel 101. The light emitting panel 101 may be formed from transparent material and may include a vertical grooves 195 and horizontal grooves 193 which may facilitate the distribution of the light from the LED array light device 103. The vertical grooves 195 and the horizontal grooves 193 may be formed from a laser (not shown) or other suitable device. The substrate of the light emitting panel 101 may be formed from acrylic which may include a mat surface or milky white diffuser panel/paper to diffuse the light from the LEDs substantially evenly across the surface to provide a bright, uniformly illuminated presentation.

The light emitting panel 101 may include side firing LEDs 191 which may focus the emitting light into a light guide. The present invention may employ to one of several edge-lighting, light-extraction technologies such as printing, etching (for example by using chemicals), forming a V shaped groove by stamping, laser or other appropriate devices in forming the light guide. The light guide may be formed with individual pixels of LED lights 141. The LED lights 191 may be red, green, blue or white (white phosphor).

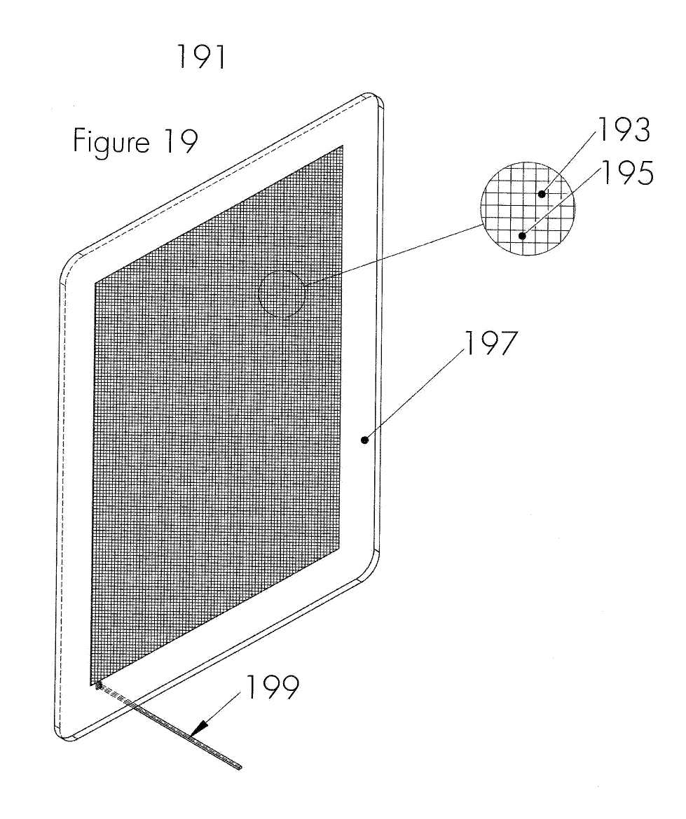

FIG. 19 illustrates a perspective view of the back of the light emitting panel 191 and illustrates a power cord 199 which may extend from the back of the light panel 191. The surface which includes the horizontal grooves 193 and the vertical grooves 195 may define a border area generally along the periphery of the light panel 191 which may be substantially free from grooves and may be substantially clear to form a border 197 for the light panel 111.

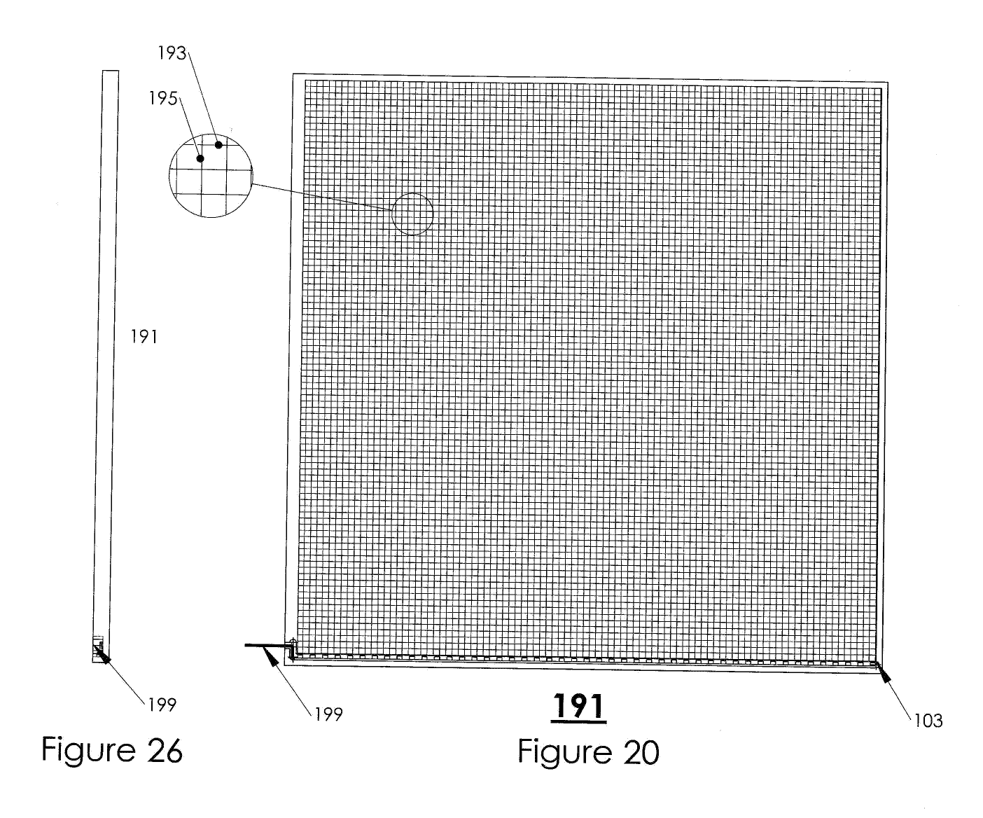

FIG. 20 illustrates a front view of the light emitting panel 101 and illustrates the horizontal groove 193, the vertical groove 191 and the power cord 199. An array of LED lights 191 extends across the top edge of the light emitting panel 101.

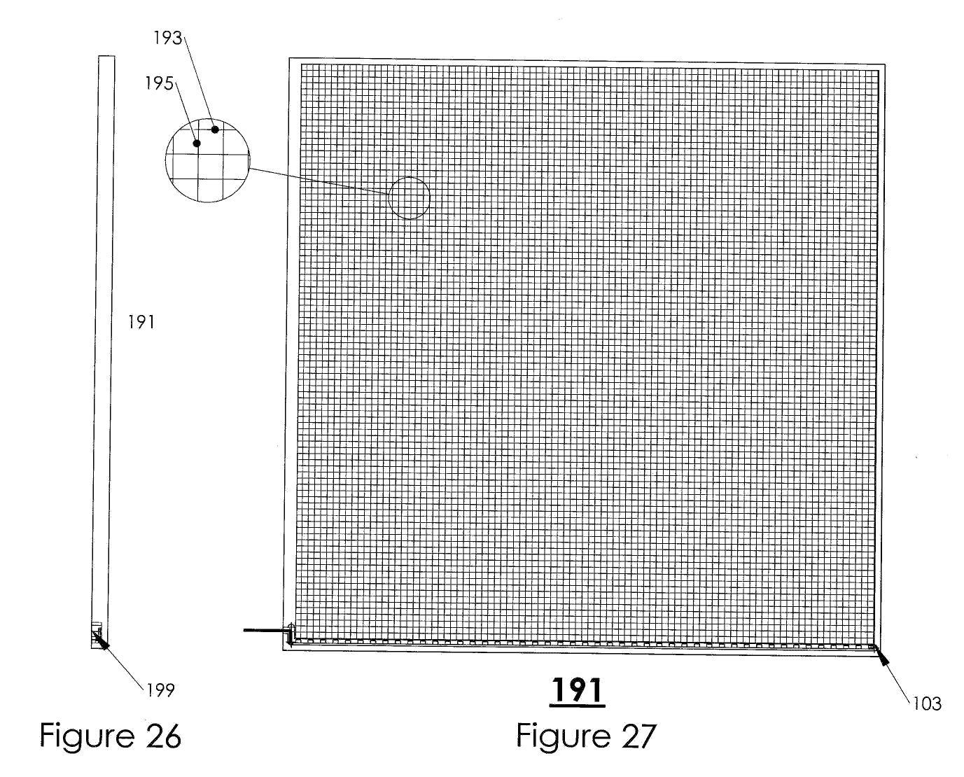

FIG. 26 illustrates a side view of the light emitting panel 101 and illustrates the LED array light device 103.

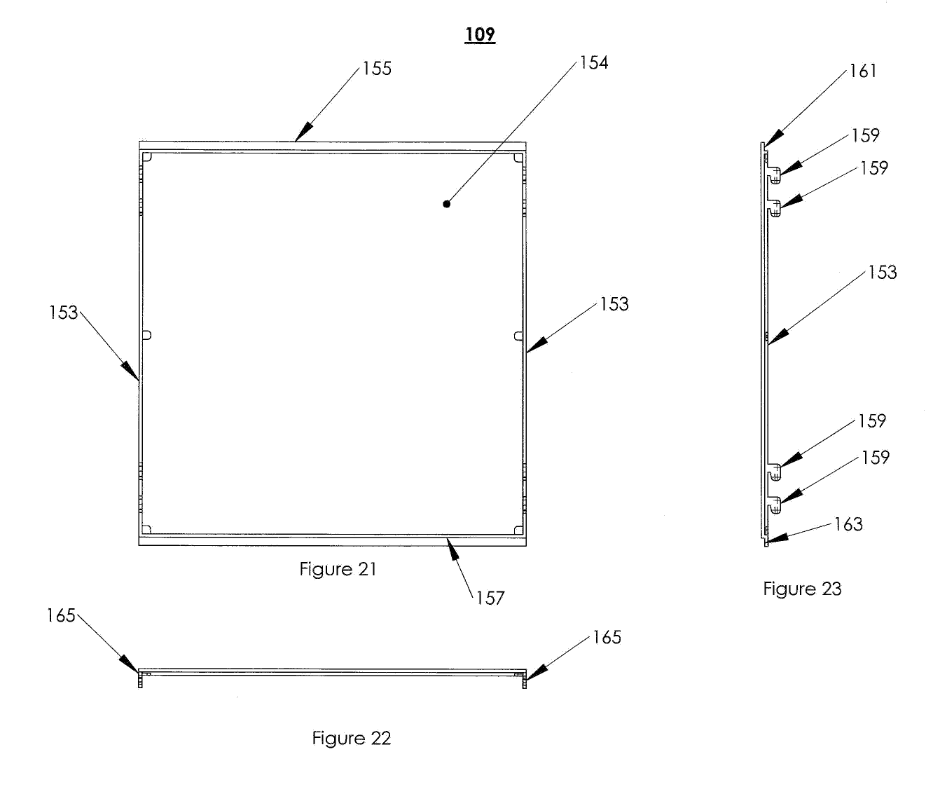

FIG. 21 illustrates a front view of the module member 109 which may include a substantially rectangular frame shape and may include other shapes. The module member 109 includes a top frame member 155 which may be connected to a pair of opposing side frame members 153 which may be connected to a bottom frame member 157.

The top frame member 155, the pair of opposing side frame members 153 and the bottom frame member 157 define a central aperture to allow users to view the film member 107.

FIG. 22 illustrates a cross section of one of the top frame member 155, the pair of opposing side frame members 153 or the bottom frame member 157 and illustrates that the frame member 155, 153, 157 may be substantially U-shaped having inward extending arms 165 in order to cooperate with the film member 107.

FIG. 23 illustrates a side view of the side frame members 153 and may include inward extending fasteners 159 which may be L shaped devices in order to fasten to the slots 119. As a consequence, the modular member 109 may be detachably connected to the frame housing 105, and the film member 107 may be replaced in order to introduce new or different indicia.

FIG. 23 illustrates that the side frame member 153 may include an outward extending overlapping portion 161 which may cooperate with and inward extending overlapping portion 163 to provide a substantially continuous appearance when connected to a adjacent modular member 109.

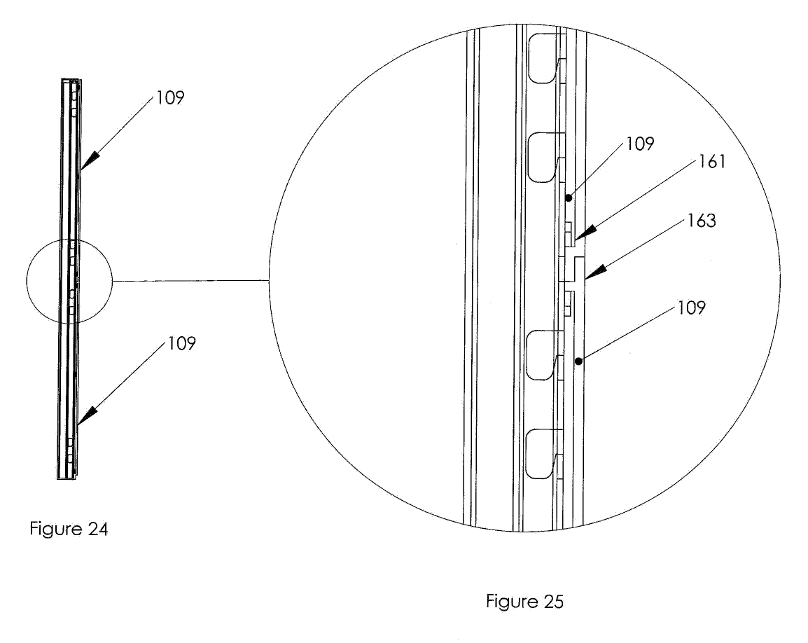

FIG. 24 illustrates a first modular member 109 which may be positioned adjacent to a second modular member 109.

FIG. 25 illustrates a section of the first modular member 109 and the second modular member 109 and illustrates the outwardly extending overlapping portion 161 cooperating with the inwardly extending overlapping portion 163 to form a substantially continuous surface.

1) A modular lighting device, comprising:
a frame housing;
a light emitting panel cooperating with the frame housing to emit light;
an edge lighting device to be positioned along an edge of the light emitting panel to provide light to the light emitting panel;
a film member including indicia to be displayed;
a modular member to cooperate with the frame housing and the film member;
wherein the modular member is detachably connected to the frame housing.

2) A modular lighting device as in claim 1, wherein the edge lighting device includes an LED.

3) A modular lighting device as in claim 1, wherein the edge lighting device includes an array of LEDs.

4) A modular lighting device as in claim 1, wherein the light emitting panel includes a depression to transmit the emitted light.

5) A modular lighting device as in claim 1, wherein the module member includes a fastener to fasten to the frame housing.

6) A modular lighting device as in claim 5, wherein the fastener is L-shaped.

7) A modular lighting device as in claim 1, wherein the module member includes a top extending portion and a bottom extending portion to cooperate with the top extending portion to form a substantially continuous surface.

8) A modular lighting device as in claim 5, wherein the frame housing includes a slot to cooperate with the fastener.

9) A modular lighting device as in claim 1, wherein the frame housing includes a central slot to cooperate with the light emitting panel.
